(19) United States
(12) Patent Application Publication
(10) Pub. No.: US 2003/0153390 A1
(43) Pub. Date: Aug. 14, 2003

(54) Expanding seal

(75) Inventor: C. Robert Samples, Akron, OH (US)

Correspondence Address: Hahn Loeser & Parks, LLP, Twin Oaks Estate, 1225 West Market Street, Akron, OH, 44313-7188, US

(73) Assignee: Akron Rubber Development Laboratory, Inc.

(21) Appl. No.: 10/366,628

(22) Filed: Feb. 12, 2003

Related U.S. Application Data
(60) Provisional application No. 60/356,220, filed on Feb. 12, 2002.

(51) Int. Cl. F16D 3/18; F16D 3/44

(52) U.S. Cl. 464/154

(57) ABSTRACT

A seal for a mass transit power transmission coupling. The seal is made at least partially of a polymeric material and configured such that the sealing surface moves radially outward under the centrifugal force created by rotation of the coupling beyond a predetermined speed. When the rotational speed of the coupling drops below the predetermined speed, the sealing surface moves radially inward and seals the coupling to prevent loss of the oil lubrication typically used on such couplings.

### TECHNICAL FIELD

This application claims the benefit of U.S. Provisional Patent Application Ser. No. 60/356,220 filed Feb. 12, 2002, and incorporated by reference herein. The invention relates generally to a seal which changes dimensions during operation and, more specifically, an annular elastic seal which has an inner sealing diameter which expands due to centrifugal force when the seal rotates at or above a predetermined speed.

### BACKGROUND OF THE INVENTION

Mass transit systems such as subway rail cars utilize power transmission couplings between the rail cars to transfer rotational power from car to car. These transmission couplings must be able to transfer power from one shaft to another, even when the shafts are misaligned such as when the cars are going around a corner or the cars buckle. Each shaft has a gear attached thereto which is housed on different sides of the coupling. The couplings utilize gears having mating teeth to enable the power transmission to the shafts while allowing them to be misaligned from each other. The gears are required to be lubricated to ensure proper movement of the gears within the housing, prevent premature wear of the gear teeth, and reduce heat build up. The gears are typically required to be lubricated with oil as opposed to grease. A seal is positioned at each end of the coupling to prevent oil from leaking out of the coupling. These prior art seals are attached to the housing of the transmission coupling and have a sealing inner diameter which registers against one of the shafts or an extended hub portion of the associated gear. These seals must flex and are therefore typically made of an elastomeric oil resistant material.

The problem with these prior art seals is that the movement caused by misalignment of the shafts and relative axial movement of the shaft/extended hub portion of the gear, causes the seal to fail prematurely. The oil may then be able to migrate out of the coupling, resulting in damage to the coupling gears and potentially leading to failure of the coupling and contamination of the surrounding equipment and subway platform.

Therefore, there remains a need in the art for a new seal which overcomes the limitations of the prior art while still providing effective oil retention.

### SUMMARY OF THE INVENTION

An object of the present invention to provide an improved seal. These and other advantages are provided by an annular seal for use on a mass transit coupling having a ring gear hub and axle shaft positioned in a co-rotating housing, the seal comprising a seal body demountably attached to the housing; an inner sealing diameter of the seal body which seals against at least one of the ring gear hub and the axle shaft when the seal is rotating below a predetermined rotational speed and wherein the inner sealing diameter expands due to centrifugal force when the seal is rotating at or above the predetermined speed.

### BRIEF DESCRIPTION OF THE DRAWINGS

The invention and developments thereof are described in more detail in the following by way of embodiments with reference to the drawings, in which:

FIG. 1 is a perspective view of a prior art power transmission coupling;

FIG. 2 is a side elevational and partial cut-away cross sectional view of the prior art power transmission coupling of FIG. 1;

FIG. 3 is a cross-sectional view of the prior art power transmission coupling of FIG. 1 showing misalignment of the hub gears;

FIG. 4 is a cross-sectional view of a power transmission coupling utilizing the seal of the present invention;

FIG. 5 is a cross-sectional view of a rotating power transmission coupling utilizing the seal of the present invention.

FIG. 6 is a cross-sectional view of a power transmission coupling utilizing another embodiment of the seal of the present invention.

### DETAILED DESCRIPTION OF THE INVENTION

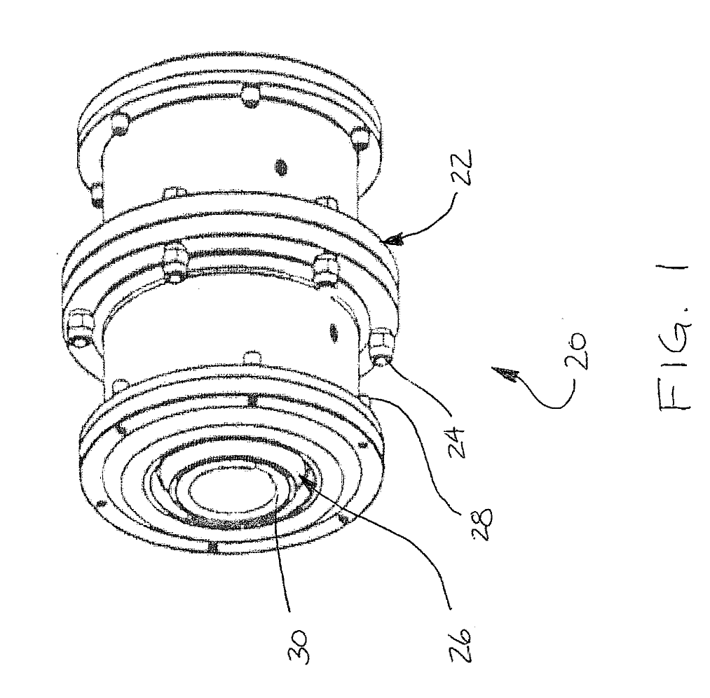

Turning now to FIG. 1 which illustrates a typical power transmission coupling assembly 20 of the type suitable for use with the present invention. The prior art coupling 20 comprises a two-piece ring gear or ring gear housing 22 bolted together at the center by a plurality of fasteners 24. Each end of the coupling 20 is attachable to a power transmission shaft of adjacent rail cars (not shown). A prior art seal 26 is shown attached to the ring gear 22 by a plurality of fasteners 28. The seal 26 seals against the surface of a hub gear or ring gear hub 30 moveably positioned within the ring gear housing 22.

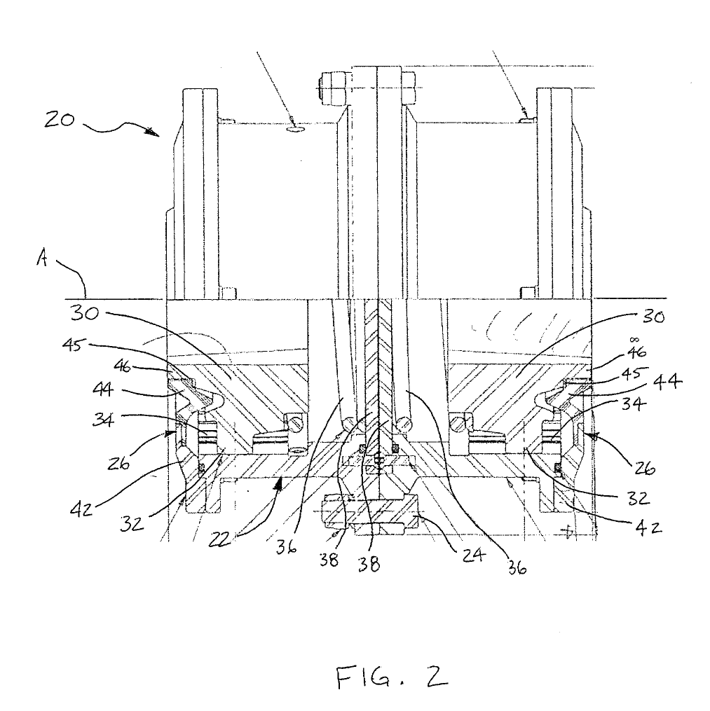

Referring now to FIG. 2, the prior art coupling assembly of FIG. 1 is shown in greater detail. Coupling assembly 20 comprises a hub gear 30 on either side of the assembly which are attached to the ends of opposing rotatable transmission shafts (not shown). The hub gears 30 have special gear teeth 32 about their outside diameter which mate with special internal gear teeth 34 of the ring gear 22. The gear teeth 32, 34 are designed to allow movement in an axial direction and at an angular orientation from the centerline A of the coupling assembly 20. The hub gears 30 are biased outward from the center of the ring gear 22 by springs 36 which register against a retainer 38 attached to each half of ring gear 22. A pair of seals 26 are attached to the ends of the ring gear 22. The seal 26 comprises a seal plate 42 typically made of steel and a seal portion 44 made of a elastomeric oil-resistant material. Seal portion 44 has an inside diameter which registers against the outside diameter of a hub extension portion 46 of the hub gear 30. A seal portion 44 may also include a steel ring 45 between the interface of the elastomeric material and the steel hub gear 30.

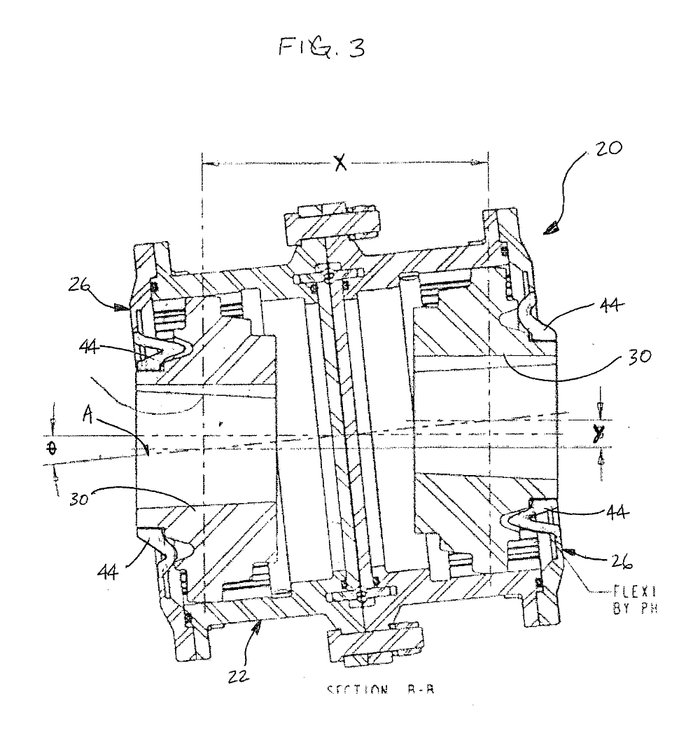

Referring now to FIG. 3, the prior art coupling of FIG. 1 is shown in cross section to show the types of displacement possible with the coupling assembly 20. The three types of displacement of the shaft misalignment is shown. Axial misalignment X, angular misalignment θ, and radial misalignment Y are possible during operation of the coupling assembly 20. These movements often occur at high frequency, typically as high as 5000 rpm or 80 hertz and, when misaligned, the flexing of the rubber at this frequency will fail the seal due to flexural fatigue in as little as 6 weeks. Desired life is 5 to 10 years.

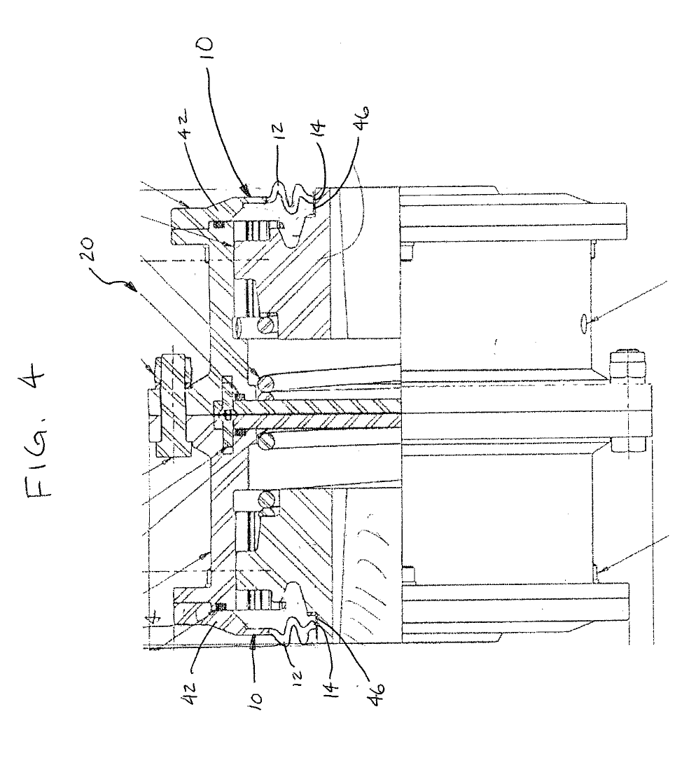

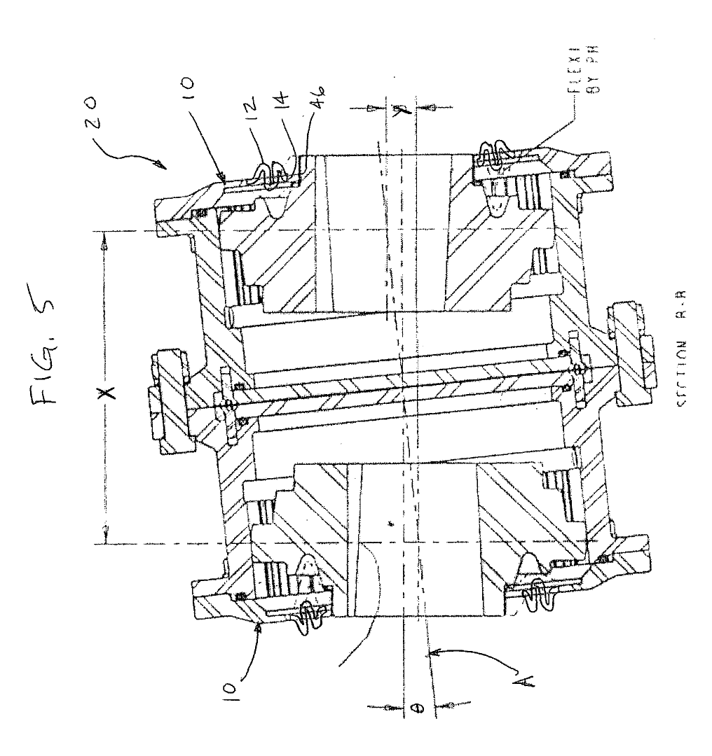

An improved seal 10 of the present invention is shown in FIG. 4. Seal 10 is also made of an oil resistant elastomeric material having a plurality of ribs or bellows 12, shown in this cross-section as accordion-like ribbing, leading to an inner diameter sealing surface 14. The ribs 12 enable the seal to stretch and retract to accommodate the range of motion of the mating outside diameter hub extension surface 46. The specialized geometry of seal 10 enables it to handle the rigorous application of use in a coupling assembly 20. In operation, the power transmission shafts (not shown), hub gears 30, and ring gear 22 are all rotating at the same speed and in the same rotational direction. As the rotational speed of the coupling assembly 20 approaches a predetermined speed, the centrifugal force on the inner diameter sealing surface 14 pulls the inner diameter sealing surface 14 radially outward away from the outside diameter hub extension surface 46 as best shown in FIG. 5. Therefore, the seal 10 is not subjected to the high frequency movements of the hub gear 30 because it is no longer in contact with the hub gear 30. The lubrication oil is unable to escape as the centrifugal force holds the fluid against the ring gear 22. As the rotational speed of the coupling assembly 20 slows below a predetermined speed, the inner diameter sealing surface 14 retracts until it contacts and seals against the hub gear 30. The lubrication oil is thus sealed in the coupling assembly. In an alternate embodiment, seal 10 has radial cuts or slits (not shown) which help allow the inner diameter sealing surface 14 to move radially outward under the centrifugal force.

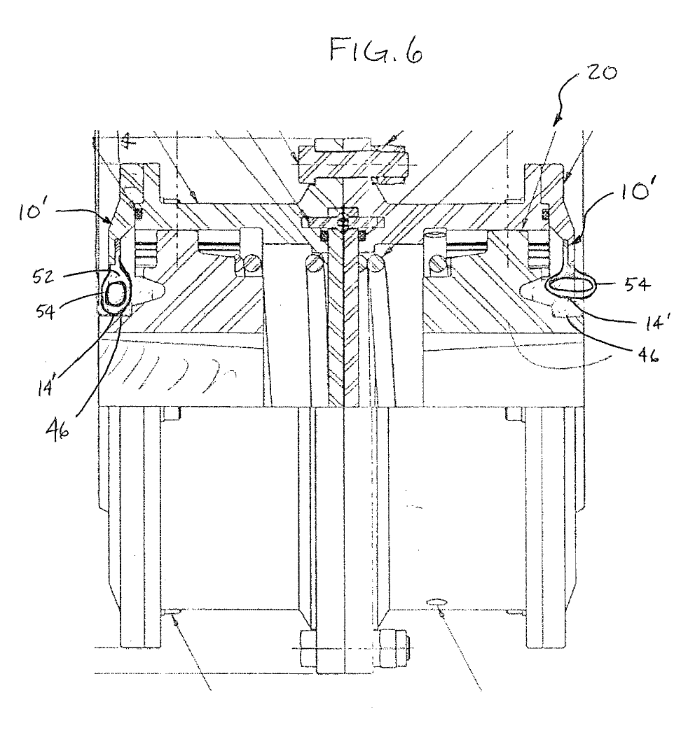

In another alternate embodiment shown in FIG. 6, the seal 10′ is shaped at least partially as an elliptical tube 52 having thin side walls 54 as shown on the left side of the FIG. 6. The thin side walls 54 collapse to allow the inner diameter sealing surface 14′ to expand under the centrifugal force as shown on the right side of FIG. 6. The tube 52 may have one or more holes (not shown) to allow air flow into or out of the tube to aid in deformation. Conversely, the tube may be filled with a liquid (not shown) to help to aid in deformation expansion of the inner diameter sealing surface.

It is contemplated that there are innumerable configurations that could be employed and not be beyond the scope of the present invention. For example, the density of the inner diameter sealing surface 14 could be increased or made of a heavier material to promote movement under the centrifugal force. Any seal configurations and material that can expand and retract automatically under centrifugal forces are contemplated by the present invention.

Although the present invention has been described above in detail, the same is by way of illustration and example only and is not to be taken as a limitation on the present invention.

What is claimed is:

1. An annular seal for use on a mass transit coupling having a ring gear hub and axle shaft positioned in a co-rotating housing, the seal comprising:
a seal body demountably attached to the housing; and
an inner sealing diameter of the seal body which seals against at least one of the ring gear hub and the axle shaft when the seal is rotating below a predetermined rotational speed and wherein the inner sealing diameter expands due to centrifugal force when the seal is rotating at or above the predetermined speed.

2. The annular seal of claim 1, wherein the seal is at least partially made of an elastomeric material.

3. The annular seal of claim 1, wherein the seal further comprises a bellows portion which facilitates radial and axial movement of an inner sealing surface at the inner sealing diameter.

4. The annular seal of claim 1, wherein the predetermined speed is approximately 100 rpm.

5. The annular seal of claim 1, wherein the seal is compatible for use with oil.

6. The annular seal of claim 1, wherein the sealing diameter is expandable radially outward beyond the range of movement of either the axle shaft or the axle shaft hub when the housing, axle shaft hub, axle shaft and seal are rotating above the predetermined speed.

7. The annular seal of claim 1, wherein the seal further comprises a tubular portion which facilitates radial and axial movement of an inner sealing surface at the inner sealing diameter formed by a portion of the tubular portion.

8. A seal for use on a mass transit coupling having a rotating ring gear hub and axle shaft positioned in a co-rotating housing, the seal comprising:
a seal mounting plate demountably attached to the housing;
a seal body attached to the mounting plate, wherein the seal body comprises an inner sealing diameter which seals against at least one of the rotating ring gear hub and axle shaft when the seal is rotating below a predetermined rotational speed and which expands due to centrifugal force when the seal is rotating at or above a predetermined speed.

9. The seal of claim 8, wherein the seal body is at least partially made of an elastomeric material.

10. The seal of claim 8, wherein the seal body comprises a circular bellows portion which facilitates radial and axial movement of an inner sealing surface at the inner sealing diameter.

11. The seal of claim 8, wherein the predetermined speed is above 50 rpm.

12. The seal of claim 8, wherein the seal body is compatible for use with oil.

13. The seal of claim 8, wherein the seal mounting plate is made of steel.

14. The seal of claim 8, wherein the seal comprises a tubular portion which facilitates radial and axial movement of an inner sealing surface at the inner sealing diameter formed by a portion of the tubular portion.

15. A power transmission coupling comprising:
a cylindrical ring gear housing;
a ring gear hub mounted in each end of the ring gear housing for attachment to an axle shaft;
wherein the ring gear hubs are adapted to move axially within the cylindrical ring gear housing;
wherein each ring gear hub is adapted to move such that the axis of the ring gear hub is transverse to the axis of the cylindrical ring gear housing;
a seal mounting plate demountably attached to each end of the cylindrical ring gear housing;
a seal body fixably attached to the seal mounting plate, wherein the seal body comprises an inner sealing diameter which seals against one of the ring gear hub and the axle shaft when the seal body is rotating below a predetermined rotational speed and which expands due to centrifugal force when the seal body is rotating at or above a predetermined speed.

16. The power transmission coupling of claim 15, wherein the seal body is made of an elastomeric material.

17. The power transmission coupling of claim 15, wherein the seal further comprises a bellows portion which facilitates radial and axial movement of an inner sealing surface at the inner sealing diameter.

18. The power transmission coupling of claim 15, wherein the predetermined speed is over 50 rpm.

19. The power transmission coupling of claim 15, wherein the seal is compatible for use with oil.

20. A method of sealing a mass transit coupling comprising the steps of:
providing a mass transit coupling having at least one axle shaft coupled to a ring gear hub mounted in a ring gear housing, wherein the axle shaft is moveable in an axial direction and moveable transverse to the axis of the housing;
attaching an annular seal to the ring gear housing, wherein the seal comprises an inner sealing diameter which seals against one of the axle shaft and the ring gear hub;
rotating the housing, the ring gear hub, the axle shaft, and the seal at or above a predetermined speed wherein the inner diameter of the seal expands due to centrifugal force.
